(19) United States
(12) Patent Application Publication
(10) Pub. No.: US 2010/0176697 A1
(43) Pub. Date: Jul. 15, 2010

(54) MODULAR FURNISHING SYSTEM AND COMPONENTS AND FURNITURE BUILT USING THEM

(75) Inventor: Paul Fuerstenau, Portland, OR (US)

Correspondence Address: KOLISCH HARTWELL, P.C., 200 PACIFIC BUILDING, 520 SW YAMHILL STREET, PORTLAND, OR, 97204, US

(73) Assignee: POWIN CORPORATION, Tigard, OR (US)

(21) Appl. No.: 12/687,787

(22) Filed: Jan. 14, 2010

Related U.S. Application Data
(60) Provisional application No. 61/144,618, filed on Jan. 14, 2009.

(51) Int. Cl. A47B 53/02; B26D 3/00

(52) U.S. Cl. 312/198; 83/39

(57) ABSTRACT

A modular furniture system that comprises a first modular three-dimensional component having x, y, z dimensions of about 18 inches by about 18 inches by about 18 inches and a horizontal member, a second three-dimensional modular component having a horizontal member and arrangable with the first modular component to form modular furniture, and a connector that has a planar middle section with a first protruding section integral with a first side of the middle section and a second protruding section integral with a second side of the middle section. The first and second protruding sections protrude substantially perpendicular relative to the planar middle section. The connector is adapted to connect together the first and second modular components.

### CROSS-REFERENCE TO RELATED APPLICATION

This application claims priority under 35 U.S.C. §119(e) to U.S. Provisional Patent Application Ser. No. 61/144,618 entitled “MODULAR FURNISHING SYSTEM AND COMPONENTS AND FURNITURE BUILT USING THEM,” filed Jan. 14, 2009, the complete disclosure of which is hereby incorporated by reference for all purposes.

### BACKGROUND OF THE DISCLOSURE

The present invention relates in general to a modular furnishing system and modular components for building a variety of furniture items and in particular to a modular furnishing system and components of such a size, shape and design so as to be easily capable of making a large number and variety of sturdy, quality, standard furniture items from a small number of types of components.

Prior furniture modules have been attempted with limited success because of a lack of simplicity, yet versatility, of design and a lack of incorporation of a formula suitable for sizing a minimum combination of modules to achieve a maximum number of furniture combinations. Lacking in simplicity of design, these prior art furniture modules, when combined, have resulted in furniture combinations that have peculiar and distinctive design features that may not be appreciated by consumers.

There is lacking in the prior art a simple design, yet highly versatile, modular furnishing system that enables consumers to have the flexibility to create standard-sized desks, dining tables, work stations, coffee tables, entertainment centers, book shelves, bedroom sets, etc., all from a minimum number of modular furniture combination types. Prior art modular furnishing systems are unduly complex, and require complicated and widely varying types of attachment, combination and assembly mechanisms and procedures. Thus, rather than use prior art modular furnishing systems, consumers have been limited in their options of achieving easily derived, simple furnishing types, having instead been required to either buy custom-made furniture to suit the consumer's needs, or having been required to engage in unduly complex processes or designs to achieve sometimes standard, but many times non-standard, furniture combinations. This, in turn, has led to increased difficulty, frustration and expense associated with creating furniture from prior art modular furnishing components.

Further, owing to the more complex prior-art designs of modular furnishing component systems, there has been difficulty and added expense in manufacturing the prior art components. This complexity has also led to an increased need for warehouse space for increased inventory Stock Keeping Units (SKU) and increased numbers of parts. There is needed a simplified modular furnishing component system that is easily mass-manufactured into a quality modular furnishing component system.

### SUMMARY OF THE DISCLOSURE

In accordance with a first aspect of the present invention, there are provided a plurality of modular furnishing components that are of ideal size and simple in design and function so as to be used alone, or readily combined with other modular components, to form a wide variety of furnishing structure combinations, including but not limited to a desk, base for a bed, dining table, coffee table, workstation, entertainment center, book shelf, window seat, hutch, cabinet, dresser, chest or closet organizer, all from a minimum number of furnishing components.

Each modular furnishing component provided in accordance with the first aspect of the present invention comprises a plurality of structural cross members, preferably made of wood frame members joined at the corners and interfaces by dowel and/or tongue and groove construction techniques, or other commonly known joining means, to form a cuboidal (3-d Square-Faced Cube) or paralleliped (3-d Rectangular-Faced Box) frame. The modular furnishing component also preferably includes an upper and/or a lower planar, rectangular-shaped, surface member having four corners. Each corner of the upper surface member is aligned with an adjacent corner of the lower surface member, with each corner being connected to its corresponding other surface member corner by L-shaped (in cross-section) stiles, or vertically oriented frame or cross members. In one embodiment of the invention the component is open, with only the structural frame members interconnecting the upper and lower surfaces at the corners.

Preferably, there are horizontally oriented rails or frame members which interconnect the vertically oriented stiles or frame members and extend lengthwise adjacent an inner surface of and around the perimeter of each upper and lower planar surface, to lend rigidity and strength to the component.

While the invention is most basically comprised of two modular component sizes (the first and third components listed below), there are preferably four basic modular component sizes in the preferred embodiment of the invention, first, a cube-shaped, modular furnishing component that is about 18×about 18×about 18 inches in dimension (x, y, z coordinates), second, a cube-shaped, modular furnishing component that is about 9×about 9×about 9 inches in dimension, third, a rectangular box-shaped modular furnishing component that is about 18×about 9×about 9 inches in dimension, and fourth, a rectangular box-shaped modular furnishing component that is about 18×about 9×about 18 inches in dimension. In accordance with this first aspect of the invention, the cross members and any surface members are preferably appropriately sized so that when combined together to form the modular furnishing component, the overall modular furnishing component is of the preferred dimensions described above to readily be combinable to form furnishing elements of standard dimensions.

In accordance with another aspect of the invention there are provided cut lists and process engineering drawings to enable easy, cost-effective, mass production of modular furnishing components. The cut lists provide the data to create modular furnishing components of the size and shapes described specifically above. These data are appropriately expressed as a formula herein so as to allow creation of varying dimensions of standardsized modular furnishing components.

In accordance with another aspect of the invention there are provided multiple uniform family of accessories for completing desired furniture designs with the aforementioned size combination modular furnishing components, including fixed cover panels and decorative inserts (square and rectangular of different styles), hinged door panels, rolling drawer insert units (for cube and rectangle components), roller platforms, spin platforms, square and rectangular shelves, table, desk top, and other plank tops.

In accordance with yet another aspect of the invention, there are a series of holes pre-drilled on the inside of each modular furnishing component allowing for installation of pegs for installing shelving within the modular furnishing component at varying levels. The holes are pre-drilled along different axes of the cube so that a shelf or other divider may be installed regardless of the orientation of the cube.

The modular components of the invention are mixed, combined, matched, stacked, and oriented relative to each other to formulate varying furnishing combinations. The components are sized appropriately such that simple combinations of the components, or the components alone, form standard-sized furnishing in accordance with commonly known building code sizes. For example, an 18 inch cube-shaped component with a 9 inch rectangular box-shaped component stacked thereon forms a standard base for a standard-sized 27-inch high desk top. As another example, a standard 36-inch high countertop is easily accommodated with two 18-inch high modular furnishing components.

Thus, the invention comprises pre-manufactured and pre-drilled cube-shaped and rectangle box-shaped frame components appropriately sized so as to form standard-sized furnishings with a minimum number of interchangeable components, each component providing the end-user multiple accessory options for each component so as to give maximum flexibility for function, storage, filing and design of resulting furnishings made with the components.

The modular furnishing frame components are preferably made of rubber wood, but are suitably made of any rigid standard building material, including but not limited to other hard woods, metal or plastic.

Another aspect of the invention includes connector brackets. An “S-shaped” cross-section bracket is conveniently used to mount a cube to the wall by screwing the bracket into the wall with an upright portion of the bracket pointing upwardly and outwardly from the wall to form a slot between the bracket and the wall, slipping the back upper portion of the frame portion of a cube-shaped or rectangular modular furnishing frame component into the resulting slot between the bracket and the wall, and securing the module to the bracket with one or more wood screws if desired.

Two modular furnishing frame components may be connected, for example to form a coffee table, by using a “U-shaped” cross section bracket to interconnect the upper inner frame portions of each component. Alternatively, two “S-shaped” brackets can be connected lengthwise together to form a “goal-post-shaped” bracket to form a “U-shaped” bracket (the upright portion of the “goal posts”) to connect two modular furnishing frame components together.

The brackets of the invention allow other standard furniture sizes, such as a 30-inch dining table top accommodated with an 18-inch high modular furnishing component having a 9-inch high modular furnishing component stacked thereon, or underneath, and a 3-inch bracket to raise the table top to the desired standard height. The formula of the present invention is disclosed and claimed which allows the creation of any standard sized furniture from a minimum overall number of modular components.

The subject matter of the present invention is particularly pointed out and distinctly claimed in the concluding portion of this specification. However, both the organization and method of operation, together with further advantages and objects thereof, may best be understood by reference to the following descriptions taken in connection with accompanying drawings wherein like reference characters refer to like elements.

### BRIEF DESCRIPTION OF DRAWINGS

FIG. 1 is a perspective view of a cube-shaped modular furnishing component of the invention having a shelf installed therein.

FIG. 2 is a perspective view of a smaller cube-shaped modular furnishing component of the invention.

FIG. 3 is a perspective view of a rectangular box-shaped modular furnishing component of the invention.

FIG. 4 is a perspective view of another rectangular box-shaped modular furnishing component of the invention.

FIG. 5 is a top down view of an embodiment of the cube-shaped modular furnishing of FIG. 1 with a flat panel upper surface removed.

FIG. 6. is a top down view of an embodiment of the smaller cube-shaped modular furnishing component of FIG. 2 with a flat panel upper surface removed.

FIG. 7 is a top down view of an embodiment of the rectangular box-shaped modular furnishing of FIG. 3 with a flat panel upper surface removed.

FIG. 8 is a top down view of an embodiment of the rectangular box-shaped modular furnishing of FIG. 4 with a flat panel upper surface removed.

FIG. 9 is a perspective view of a filing drawer and roller guide assembly adapted for inclusion in the basic cube-shaped modular furnishing component of the invention (without the shelf installed).

FIG. 10 is a perspective view of a desk created out of modular furnishing components of the invention with a top plank resting thereon forming the desk top.

FIG. 11 is a perspective view of a coffee table formed from three cube-shaped modular furnishing components of the invention connected with a bracket (not shown in FIG. 5) in accordance with another aspect of the invention.

FIG. 12 is a perspective view of an entertainment center made of the modular furnishing components.

FIG. 13 is a perspective view of a closet organizing system made of the modular furnishing components.

FIG. 14 is a perspective view of a shaped bracket in accordance with another aspect of the present invention.

FIG. 15 are perspective views of brackets in accordance with another aspect of the invention.

FIG. 16 is side views showing the u-shaped brackets of FIG. 15 attaching together two modular components.

FIG. 17 is side views showing the shaped bracket of FIG. 14 attaching together a modular component and a furniture accessory (left panel), and securing a modular component to a wall (right panel).

FIG. 18 is a perspective view showing installation of a panel covering onto one of the open sides of a cube-shaped modular furnishing component and of castors, attached to a bottom panel, onto the bottom of the cube-shaped component in accordance with the invention.

FIG. 19 is a perspective view of a turn-table pedestal for one or more stacked cube-shaped modular furnishing component(s) of the invention.

FIG. 20 is a side view taken along the lines 20-20 in FIG. 1 of a pre-drilled hole pattern on the inside of a cube-shaped modular furnishing component of the invention.

FIG. 21 is a perspective view of a rolling filing cabinet made of a modular furnishing component of the invention and having a rectangular box-shaped cabinet with a drawer in it.

FIG. 22 is a perspective view of a dresser drawer and roller guide assembly adapted for inclusion in the rectangular box-shaped modular furnishing components of the invention.

FIG. 23 is a perspective view of a free-spinning storage column and book shelf comprised of a plurality of cube-shaped modular furnishing components, two modular rectangular box-shaped furnishing components on top and resting on a turn-table pedestal.

### DETAILED DESCRIPTION OF THE DISCLOSURE

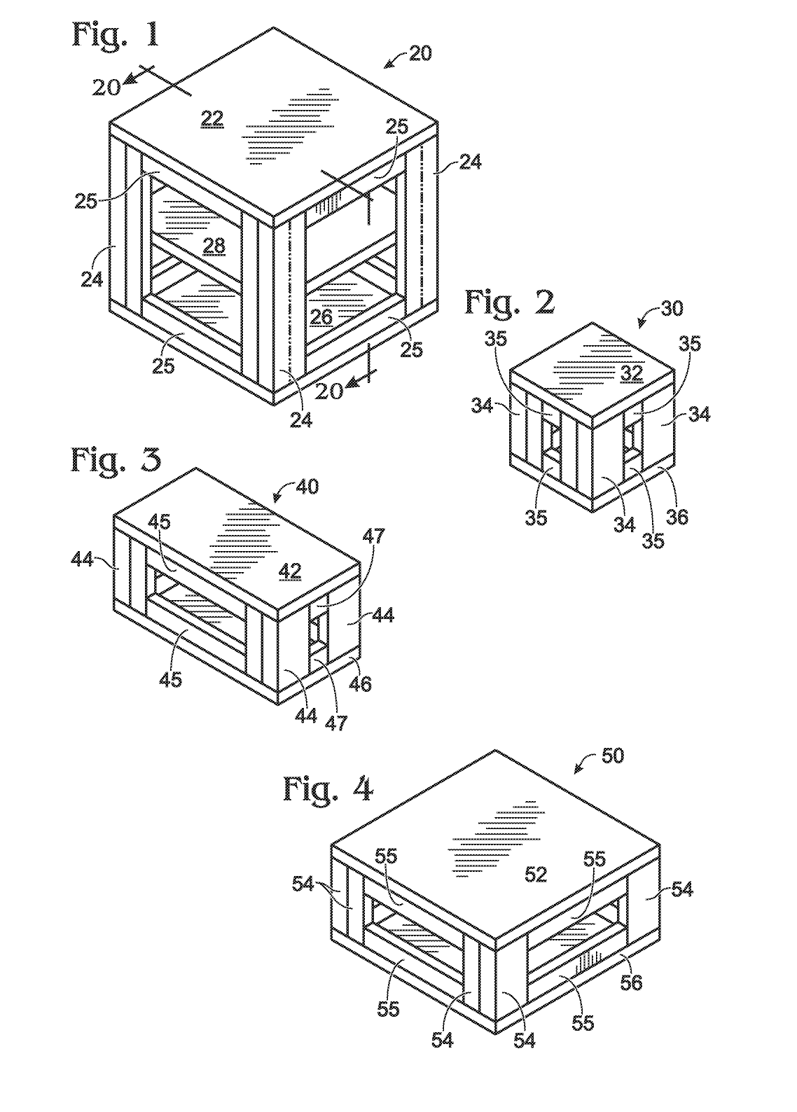

Referring to FIG. 1, a standard cube-shaped modular furnishing component 20 comprising a flat panel upper surface 22, a plurality of vertical frame members (or stiles) 24, a plurality of horizontal frame members (or rails) 25, and base flat panel lower surface 26 is shown. The modular furnishing component 20 further comprises a shelf 28 installed on a series of pegs inserted in pre-drilled holes 2 (not shown in FIG. 1, but shown in FIG. 20) in a manner conventional in the shelving art. Shelf 28 may include a notched corner to allow for wires or cords from an electronic device (e.g., a DVD player) to be fed through the notch. Component 20 is characterized in that the perimeter of each of the six sides comprising the cube-shape design is square in shape.

Referring to FIG. 20, the pre-drilled holes 2 can be seen having been drilled on an inner surface of both horizontal frame members 25 and both vertical frame members 24. Though unable to be seen in FIG. 20, there are matching pre-drilled holes on the facing inner surfaces of both horizontal frame members 25 and both vertical frame members 24 closest to the viewer of the perspective view of FIG. 20.

Returning to FIG. 1, it will be appreciated by those of ordinary skill in the art that neither flat panel upper surface 22 nor flat panel lower surface 26 need be employed as part of the modular furnishing component 20, but preferably one or both flat panels may be added to close one of the surfaces of the furnishing component to lend rigidity and as may be desirable for the end use of the component in building a piece of furniture.

Preferably the standard cube-shaped modular furnishing component 20 is of a standard outside dimension size of about 18×about 18×about 18 inches (x, y, z coordinates). However, it will be appreciated that other standard sizes of a cube may be employed without departing from the true scope and spirit of the invention.

To construct the cube-shaped modular furnishing component 20, two vertical support frame members (or stiles) 24 and upper and lower horizontal support frame members (or rails) 25 may be formed into a rectangular frame. Four such square frames may be combined using a construction method further described in this disclosure or any method otherwise commonly known in the industry to form the frame of the cube-shaped modular furnishing component 20. For example, mortise and tenon, English dovetailing, tongue and groove, or dowel and groove construction methods can be employed to join the various pieces to form furnishing component 20. After the four square frames are joined to form a cube-shaped frame, an upper surface 22 and/or a lower surface 26 are preferably added. Alternatively, corners of the cube-shaped modular furnishing component 20 may be first constructed with vertical support frame members 24.

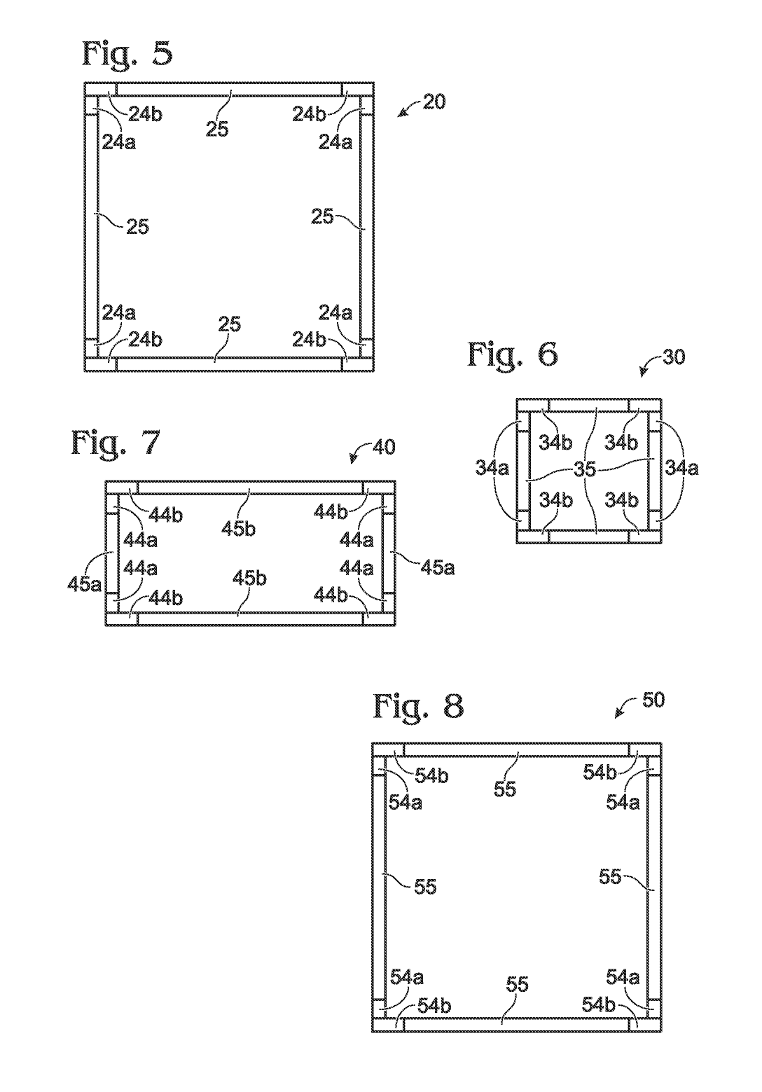

FIG. 5 shows an embodiment of FIG. 1 where any two vertical support frame members 24—shown as 24a and 24b—forming the corner of component 20 are of two different widths. In this alternative formation of the component 20, upper and lower horizontal frame members 25 are joined to interconnect each of the corners. Then, as described above, upper surface 22 and/or lower surface 26 are preferably added.

Under this embodiment, the various components for constructing component 20 number in quantity, and are approximately sized (width, length, thickness in inches), as follows: one upper surface 22 sized about 18×about 18×about ¾ inches; one lower surface 26 sized about 18 inches×about 18 inches×about ¾ inches; four bottom (partially shown in FIG. 1) and four upper (shown in FIG. 5) members or rails 25 each sized about 1¼ inches×about 14 inches×about ¾ inches; four vertical frame members or stiles 24a each sized about 1¼ inches×about 16½ inches×about ¾ inches; four vertical frame members or stiles 24b each sized about 2 inches by about 16½ inches by about ¾ inches; and in some embodiments an adjustable shelf 28 sized about 16¼ inches×about 16¼ inches×about ¾ inches.

Referring to FIG. 2, a standard cube-shaped modular furnishing component 30 comprising a flat panel upper surface 32, a plurality of vertical frame members (or stiles) 34, a plurality of horizontal frame members (or rails) 35, and a base flat panel lower surface 36 is shown. The modular furnishing component 30 may also include a shelf (not shown in FIG. 2) installed on a series of pegs inserted in pre-drilled holes 2 (not shown in FIG. 2) in a manner conventional in the shelving art.

Preferably the standard cube-shaped modular furnishing component 30 is of a standard size of about 9×about 9×about 9 inches (x, y, z coordinates). However, it will be appreciated that other sizes of a cube may be employed without departing from the true scope and spirit of the invention. Component 30 is characterized in that the perimeter of each of the six sides comprising the cube-shape design is square in shape.

To construct the cube-shaped modular furnishing component 30, two vertical support frame members (or stiles) 34 and upper and lower horizontal support frame members (or rails) 35 may be formed into a square frame. Four such square frames may be combined using a construction method further described in this disclosure or any method otherwise commonly known in the industry to form the frame of the cube-shaped modular furnishing component 30. For example, mortise and tenon, English dovetailing, tongue and groove, or dowel and groove construction methods can be employed to join the various pieces to form furnishing component 30. After the four square frames are joined to form a cube-shaped frame, an upper surface 32 and/or a lower surface 36 are preferably added. Alternatively, corners of the cube-shaped modular furnishing component 30 may be first constructed with vertical support frame members 34.

FIG. 6 shows an embodiment of FIG. 2 where any two vertical support frame members 34—shown as 34a and 34b—forming the corner of component 30 are preferably of two different widths. In this alternative formation of the component 30, upper and lower horizontal frame members 35 are joined to interconnect each of the corners. Then, as described above, upper surface 32 and/or lower surface 36 are preferably added.

Under this embodiment, the various components for constructing component 30 number in quantity, and are approximately sized (width, length, thickness in inches), as follows: one upper surface 32 sized about 9×about 9×about ¾ inches; one lower surface 36 sized about 9 inches×about 9 inches×about ¾ inches; four bottom (partially shown in FIG. 2) and four upper (shown in FIG. 6) members or rails 35 each sized about 1¼ inches×about 5 inches×about ¾ inches; four vertical frame members or stiles 34a each sized about 1¼ inches×about 7 9/16 inches×about ¾ inches; and four vertical frame members or stiles 34b each sized about 2 inches by about 7 9/16 inches by about ¾ inches.

Referring to FIG. 3, a standard rectangular box-shaped modular furnishing component 40 having a flat panel upper surface 42, a plurality of vertical frame members (or stiles) 44, a plurality of horizontal frame members (or rails) 45, and a base flat panel lower surface 46 is shown.

Preferably the standard rectangular box-shaped modular furnishing component 40 is of a standard size of about 18×about 9×about 9 inches (x, y, z coordinates). However, it will be appreciated that other standard sizes may be employed without departing from the true scope and spirit of the invention. Component 40 is characterized in that the perimeter of each of the four sides comprising the sides of the rectangular box-shape design is rectangular in shape with lengths of each rectangle perimeter being longer than the heights thereof, and further is characterized in that the perimeter of each of the two ends of the rectangular box-shaped design is square in shape.

To construct the rectangular box-shaped modular furnishing component 40, two vertical support frame members (or stiles) 44 and upper and lower horizontal support frame members (or rails) 45 may be formed into a rectangular 40 frame. Two such rectangular frames are used. Further, two vertical support frame members 44 and upper and lower horizontal support frame members 47 (shorter rails) may be formed into a square frame. Two such square frames are also used. The two square frames are joined with the two rectangular frames, with one square frame at each end of the rectangular frames using a construction method further described in this disclosure or any method otherwise commonly known in the industry to form the frame of the rectangular box-shaped modular furnishing component 40. For example, mortise and tenon, English dovetailing, tongue and groove, or dowel and groove construction methods can be employed to join the various pieces to form furnishing component 40. After the frames are joined to form a rectangular box shaped frame, an upper surface 42 and/or a lower surface 46 are preferably added. Alternatively, corners of the rectangular box-shaped modular furnishing component 40 may be first constructed with vertical support frame members 44.

FIG. 7 is an embodiment of FIG. 3 where any two vertical support frame members 44—shown as 44a and 44b—forming the corner of component 40 are preferably of two different widths. In this alternative formation of the component 40, upper and lower horizontal frame members 45a and 45b are joined (as shown for the upper horizontal frame members in FIG. 7 but the lower horizontal frame members, which are not shown, are likewise joined) to interconnect each of the corners. Then, as described above, upper surface 42 and/or lower surface 46 are preferably added.

Under this embodiment, the various components for constructing component 40 number in quantity, and are approximately sized (width, length, thickness in inches), as follows: one upper surface 42 sized about 9×about 18×about 23/32 inches; one lower surface 46 sized about 9 inches×about 18 inches×about 23/32 inches; two bottom (partially shown in FIG. 3) and two upper (shown in FIG. 7) members or rails 45a each sized about 1¼ inches×about 5 inches×about ¾ inches; two bottom (partially shown in FIG. 3) and two upper (shown in FIG. 7) members or rails 45b each sized about 1¼ inches×about 14 inches×about ¾ inches; four vertical frame members or stiles 44a each sized about 1¼ inches×about 7 9/16 inches×about ¾ inches; and four vertical frame members or stiles 44b each sized about 2 inches by about 7 9/16 inches by about ¾ inches.

Referring to FIG. 4, a standard rectangular box-shaped modular furnishing component 50 having a flat panel upper surface 52, a plurality of vertical frame members 54, a plurality of horizontal frame members 55, and a base flat panel lower surface 56 is shown.

Preferably the standard rectangular box-shaped modular furnishing component 50 is of a standard size of about 18×about 9×about 18 inches (x, y, z coordinates). However, it will be appreciated that any other sizes or shapes may be employed without departing from the true scope and spirit of the invention. Component 50 is characterized in that the perimeter of each of the four sides comprising the sides of the rectangular box-shape design is rectangular in shape with lengths of the rectangle being longer than the heights hereof, and further is characterized in that the perimeter of each of the two upper and lower surfaces comprising the rectangular box-shaped design is square in shape.

To construct the rectangular box-shaped modular furnishing component 50, two vertical support frame members (or stiles) 54 and upper and lower horizontal support frame members (or rails) 55 may be formed into a rectangular frame. Four such rectangular frames may be combined using a construction method further described in this disclosure or any method otherwise commonly known in the industry to form the frame of the rectangular box-shaped modular furnishing component 50. For example, mortise and tenon, English dovetailing, tongue and groove, or dowel and groove construction methods can be employed to join the various pieces to form furnishing component 50. After the four rectangular frames are joined to form a rectangular box-shaped frame, an upper surface 52 and/or a lower surface 56 are preferably added. Alternatively, corners of the component 50 may be first constructed with vertical support frame members 54.

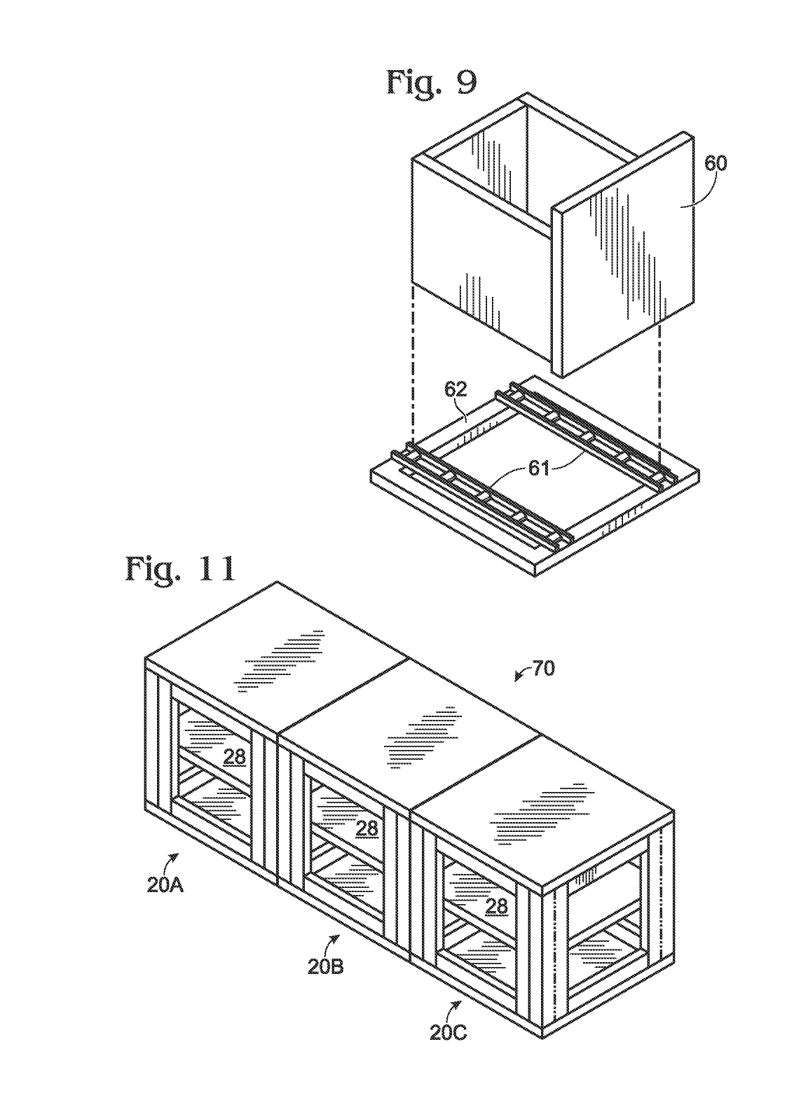

FIG. 8 is an embodiment of FIG. 4 where any two vertical support frame members 54—shown as 54a and 54b—forming the corner of component 50 are of two different widths. In this alternative formation of the component 50, upper and lower horizontal frame members 55 are joined to interconnect each of the corners. Then, as described above, upper surface 52 and/or lower surface 56 are preferably added.

Under this embodiment, the various components for constructing component 50 number in quantity, and are approximately sized (width, length, thickness in inches), as follows: one upper surface 52 sized about 18×about 18×about 23/32 inches; one lower surface 56 sized about 18 inches×about 18 inches×about 23/32 inches; four bottom (partially shown in FIG. 1) and four upper (shown in FIG. 8) members or rails 55 each sized about 1¼ inches×about 14 inches×about ¾ inches; four vertical frame members or stiles 54a each sized about 1¼ inches×about 7 9/16 inches×about ¾ inches; and four vertical frame members or stiles 54b each sized about 2 inches by about 7 9/16 inches by about ¾ inches.

Referring to FIG. 9, there is shown a file drawer 60, square base frame member 62 and roller bearing file drawer guides 61 adapted for inclusion in the basic cube-shaped modular furnishing component 20 of the invention (without the shelf installed).

The square base frame member 62 is sized appropriately so as to fit within a bottom portion of cube-shaped modular furnishing component 20. Once the frame member 62 with drawer guides 61 is located in the bottom portion of cube-shaped modular furnishing component 20, a plurality of wood screws are preferably placed in the frame member 62 to screw the frame member to lower horizontal frame components 25 or lower surface 26 of cube-shaped modular furnishing component 20. After installation of the base frame member 62 with drawer guides 61, file drawer 60 can be placed for sliding movement along the drawer guides within modular furnishing component 20.

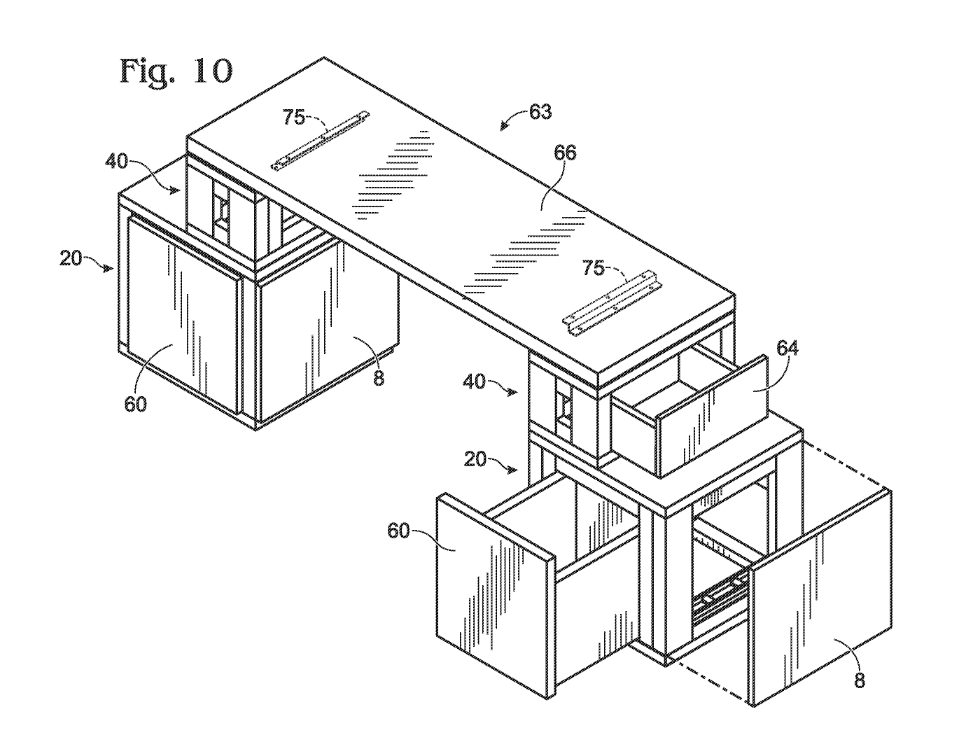

In this fashion, a file drawer 60 may be located in any area of a piece of furniture where there is located a modular furnishing component 20. Thus, for example as shown in FIG. 10, two modular furnishing components 20 are employed in a desk combination 63, each modular furnishing component 20 having a file drawer 60 installed therein. The desk combination 63 is further comprised of two modular furnishing components 40, each stacked on top of a modular furnishing component 20.

Modular furnishing component 40 also has a file drawer 64 therein. As shown in FIG. 22, file drawer 64 is constructed of a similar frame 68 and roller guide assembly 67, 69 as that of file drawer 60, except it is of the appropriate dimensions to fit within a bottom portion of modular furnishing component 40. It will be appreciated that a file drawer can be constructed to fit into any of the modular components of the invention. For example, Drawers may also be constructed for inclusion within component 30 and 50, which is constructed of a similar frame and roller guide assembly as that of file drawers 60 and 64, except the drawers are respectively constructed of the appropriate dimensions to fit within a bottom portion of modular furnishing component 30, 50 respectively.

Returning to FIG. 10, desk combination 63 further comprises a plank desk top 66 to provide a working and writing surface on the upper portion of the desk combination 63. It will be appreciated by those of ordinary skill in the art that flat panels, hinged doors or decorative inserts 8 (see FIG. 23) may be employed on a surface of modular furnishing component 20 as desirable to finish the desired look of the furnishing component as used in particular furnishing design. Decorative inserts 8 may be stylized to look like wood, glass, or any other finish so desired to provide the desired furniture look.

FIG. 11 illustrates the use of three modular furnishing components 20A-20C, each having upper and lower surfaces 22 and 26, respectively, and oriented side-by-side, so as to provide a coffee table 70. Each of the modular furnishing components 20A-20C has a shelf member 28.

As shown in FIGS. 14-17, another aspect of the invention includes connector brackets. FIG. 14 shows a curved or “S-shaped” cross-section bracket 75 with holes 77, 78. Bracket or connector 75 may include a middle, substantially planar, section with a first protruding section or member integral with a first side of the middle section and a second protruding section or member integral with a second side of the middle section. The first and second protruding sections or members may then protrude substantially perpendicular relative to the middle section. The first and second protruding sections or members may protrude in opposite directions relative to the middle section.

Holes 77, 78 are provided in the first and second protrusion sections or members for allowing passing through of a plurality of wood screws or nuts and bolts to interconnect the brackets and frame members as described herein. In some embodiments, the middle section and the first protruding member define a first space or area and the middle section and the second protruding member define a second space or area. In some embodiments, the first and second space or area are sized to fit any of horizontal members 25, 35, 45, and 55. In some embodiments, the first and second areas may be sized to fit other components of the modular furniture system, and the first and second areas may each be configured or sized the same or differently.

The left pane of FIG. 17 shows how bracket 75 is conveniently used to secure two modular components together. For example, one or more screws can be inserted through holes 77 of bracket 75 into a top portion of a lower modular component while one or more screws can be inserted through holes 78 of bracket 75 into a bottom portion of another modular component or furniture accessory positioned above the lower modular component. In FIG. 17, bracket 75 is shown attached to a table surface 66, but it will be appreciated that bracket 75 can secure any two components or furniture components together. It will also be appreciated that bracket 75 can secure together either stacked or adjoining components.

The right panel of FIG. 17 shows that bracket 75 can also be used to secure a modular furnishing component to the wall by screwing the bracket into the wall with an upright portion of the bracket pointing upwardly and outwardly from the wall to form a slot between the bracket and the wall, slipping the back upper horizontal frame member 25, 35, 45 or 55 of the frame portion of a modular furnishing component 20, 30, 40 or 50, respectively, into the resulting slot between the bracket and the wall, and securing the module to the bracket with one or more wood screws if desired. It will be appreciated that bracket 75 can also be situated to point outwardly and either downwardly to secure a back lower horizontal frame member 25, 35, 45, or 55, or sidewardly to secure a vertical frame member 24, 34, 44, or 54 of a modular component to a wall.

Bracket 75 may sized as necessary to secure together the various features above. For example, bracket 75 may create a space of just over about ¾ inches between the wall and a protruding portion of bracket 75 to allow for the about ¾ inch thickness portion of any of the above vertical or horizontal frame members to fit inside the space to secure the fitted frame member to the wall. In some embodiments, the length of the middle section to a distal end of the first protruding section may be about 1⅛ inches, and to a distal end of the second protruding section may be about 1⅛ inches. Each corner of the distal end of the first and second protruding section may be rounded. Each rounded corner may have a radius of about ½ inch.

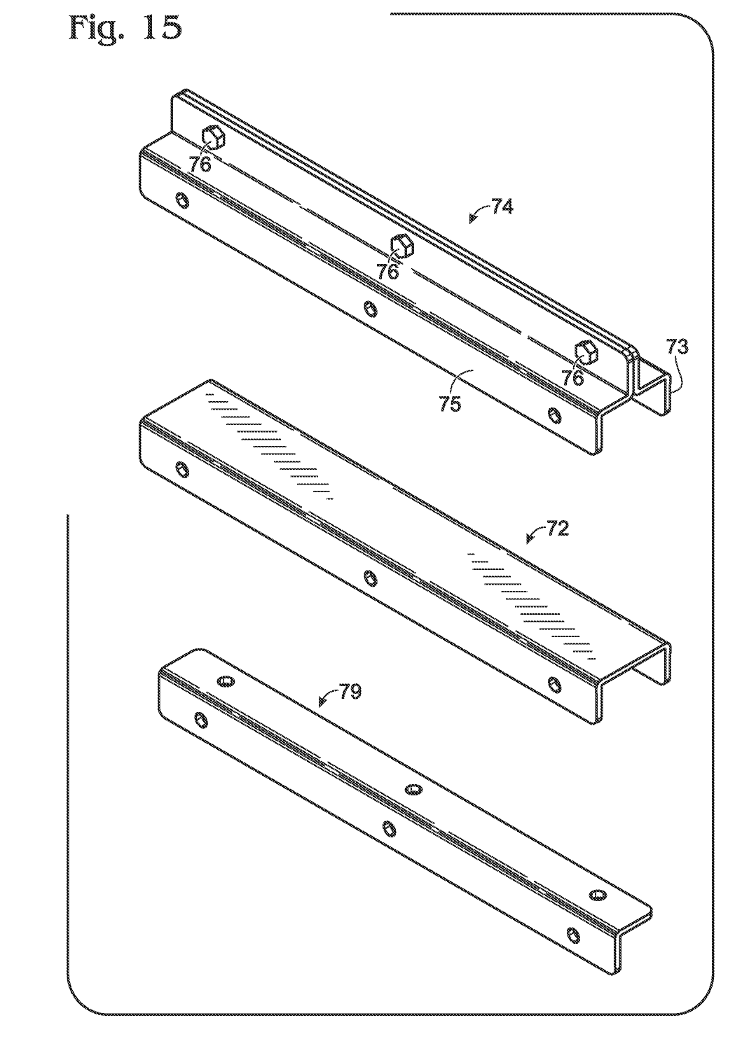

From bottom to top, FIG. 15 shows an L-shaped bracket 79, a u-shaped bracket 72, and a u-shaped bracket 74 formed by combining two s-shaped brackets 73, 75 with a screw 76. L-shaped bracket member 79 is also useful to mount a modular furnishing component to the wall, to another furnishing component, to fix a plank member on the component, to fix another accessory on the component, or otherwise to interconnect modular furnishing and other components as will be appreciated by those of ordinary skill in the art. It will be appreciated that L-shaped bracket 79 may sized as necessary to secure together the various features above.

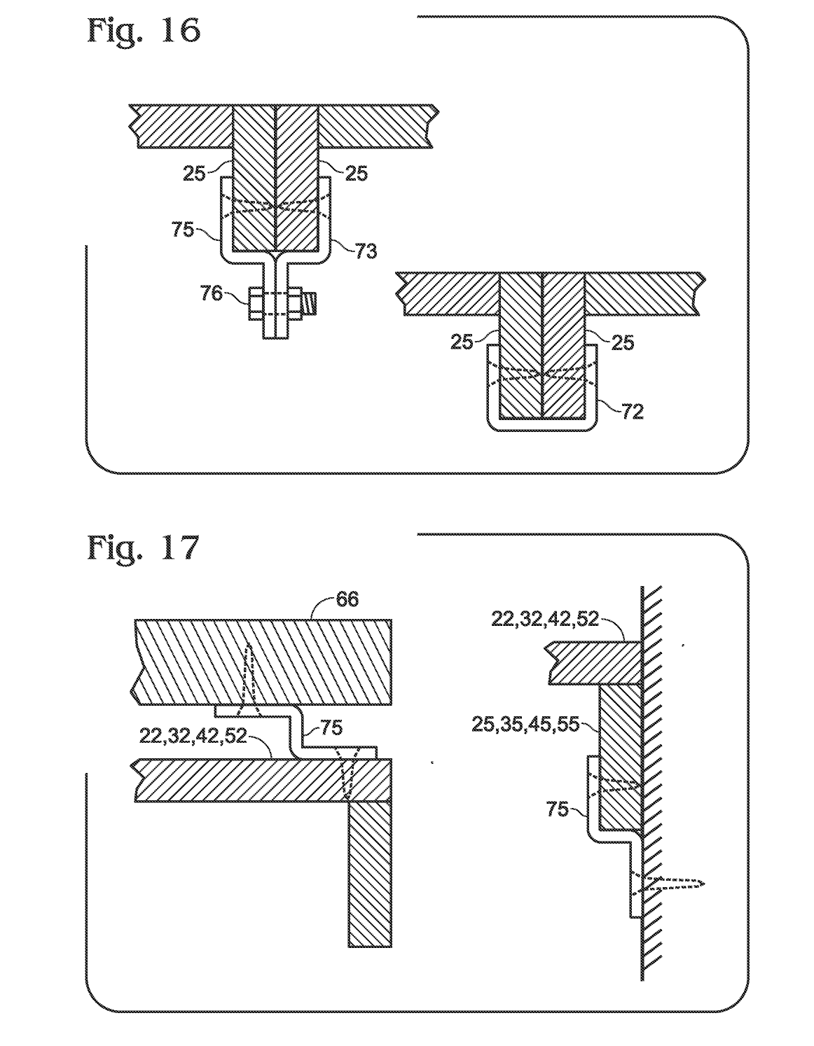

U-shaped brackets 72, 74 can be sized to secure together adjoining modular components. For example, FIG. 16 shows that a horizontal frame member 25 (shown in cross section in FIG. 16) of each of two modular furnishing components 20 are firmly joined together by a U-shaped (cross section) bracket 72.

Alternatively, U-shaped bracket 74 may also be formed by combining two S-shaped (cross section) brackets 73, 75 lengthwise, with a plurality of bolts 76 to form the “goal-post”-shaped, U-shaped bracket 74. U-shaped bracket 74 may then be used in the same way as U-shaped bracket 72 to combine two horizontal frame members 25 of cube-shaped modular furnishing components 20. Further, U-shaped brackets 72 (and/or 74) may be used to interconnect adjacently positioned horizontal frame members 25, 35, 45, and/or 55, of modular furnishing components 20, 30, 40 and/or 50, respectively, or any combination of these, to allow for a wide variety of connections of modular furnishing components to create various furniture designs. In fact, brackets 72, 74, 75, and 79 can each be used in the same manner as described herein in association with one of the other brackets. It will be appreciated that U-shaped brackets 72, 74 may sized as necessary to secure together the various features above.

It will be appreciated by those of ordinary skill in the art that varying lengths of the above described brackets may be incorporated to interconnect furnishing modules, connect a module or modules to the wall, or to interconnect other furnishing components, such as plank tops, to furnishing modules. It will also be appreciated that other types of connectors can be employed, such as double-sided tape or dowels, to interconnect a modular component with other components or with accessories, or to connect a modular component to a wall. In some embodiments, modular components, accessories, etc. will not be interconnected at all, but will be attached, adjoining, or stacked without any connector connecting them together.

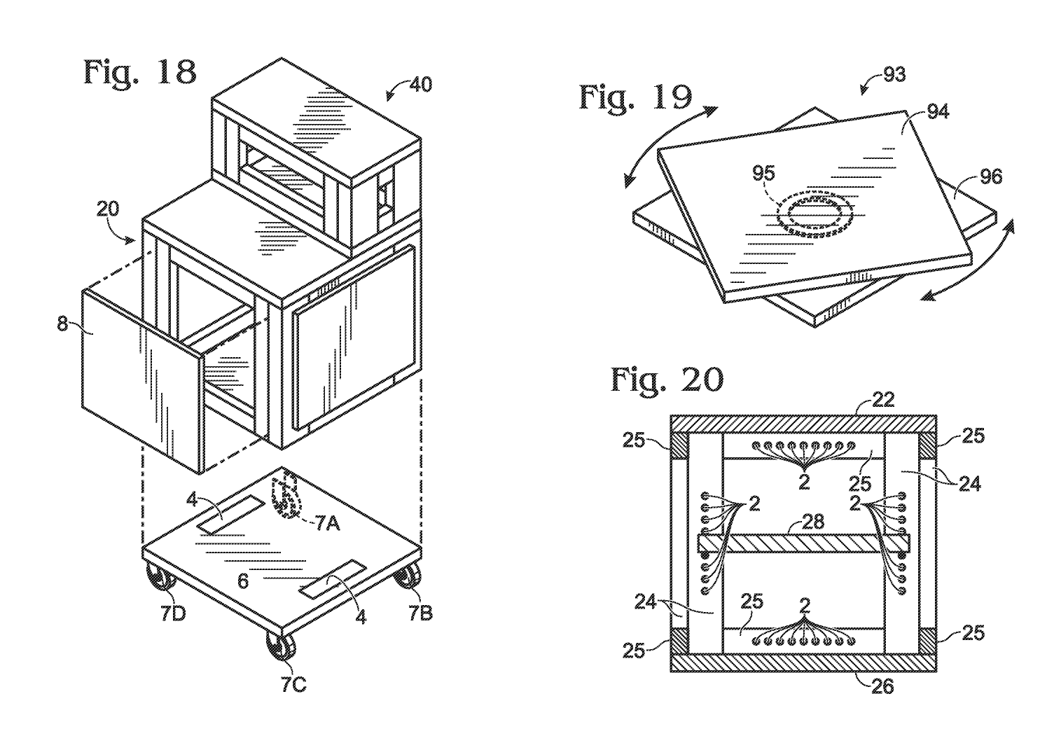

Referring to FIG. 18, there is shown a cube-shaped modular furnishing component 20 resting upon a rolling castor base 6. Rolling castor base 6 has four free-spinning castor wheels 7A-D. The modular furnishing component 20 may be easily fastened to the rolling castor base 6 with a plurality of wood screws or double-sided tape 4. The base portion of rolling castor base 6 either may form the base of modular furnishing component 20 (or may be added thereto). A decorative panel 8 may also be installed with double-sided tape 4 on modular furnishing component 20. A rectangle box-shaped modular furnishing component 40 rests on top of the modular furnishing component 20. Modular furnishing component 40 has a drawer 64 installed thereon. As also shown in FIG. 18, modular furnishing component 20 further has an upper flat panel surface 22 as well.

Another accessory, a spinning platform 93, for the modular furnishing component system of the invention is shown in FIG. 19 comprising two flat surface panels, upper panel 94 and lower panel 96, interconnected with a circular roller bearing mount 95 as well known in the art, such that the upper panel 94 is easily rotatable relative to the lower panel 96. As such, the spinning platform 93 may be used as a rotatable platform base for a cube-shaped modular furnishing component 20, with the modular furnishing component being attached to the upper panel 94 of the spinning platform 93 with a plurality of wood screws or as desired.

As shown in FIG. 23, a storage/book shelf column 100 comprised of three cube-shaped modular furnishing components 20A-20C, and two rectangular box-shaped modular furnishing components 40A-40B, may be stacked one on top of the other, as shown, and resting pivotably upon a spinning platform 93 such that the entire column is able to spin freely for easy access to various portions of the column 100.

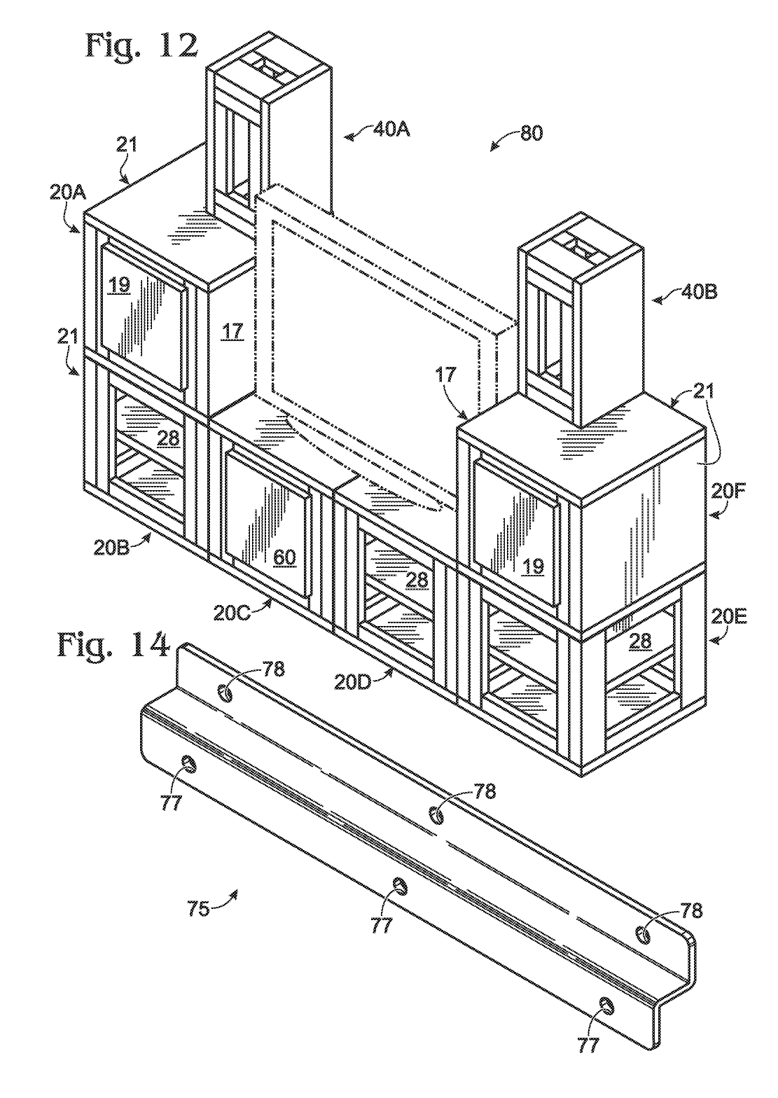

Referring to FIG. 12, there is shown an entertainment center 80 comprised of six cube-shaped modular furnishing components 20 (A-F), with some components 20 being accessorized differently than other components, and two rectangular box-shaped modular components 40 (A-B) being used to stack CD or DVD cases. As part of the entertainment center 80, modular furnishing component 20A could include two flat wooden side and back panels 21 and a hinged front door panel 19. Modular furnishing component 20A could further include a decorative insert 17. Further, modular furnishing component 20B could include three flat wooden side and back panels 21 and a shelf member 28. Modular furnishing component 20C of entertainment center 80 includes a filing drawer 60. Modular component 20D of entertainment center 80 includes a hinged front door panel 19 and may include a plurality of shelves 28. Modular component 20E of the entertainment center 80 includes a shelf member 28. Modular component 20F includes a decorative insert 17, two flat panel side members 21, and a hinged front door panel 19. Each of the modular furnishing components 20 A-F of the entertainment center 80 include, as preferable for each such component, upper and lower flat panel surface members 22, 26. Also, a plank member 66 may be employed, optionally, as part of the entertainment center 80 and resting upon modular components 20C and 20D. It will be appreciated that the entertainment center 80 is just one of many possible combinations of entertainment centers able to be built using the modular furnishing components of the invention.

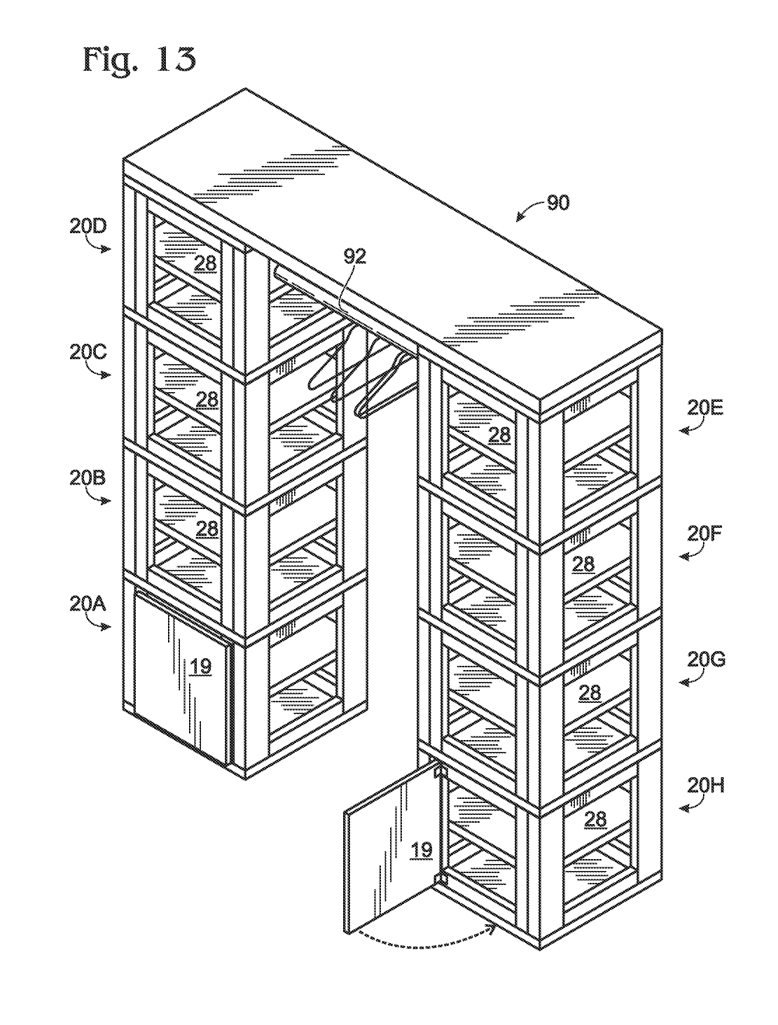

Referring to FIG. 13, a closet organizing system 90 is shown comprised of two columns of four stacked cube-shaped modular furnishing components 20 (A-H). Each of the two bottom modular furnishing components 20A and 20H has a hinged front door panel 19. Each of the four modular furnishing components 20B, 20C, 20F, and 20G has a shelf 28 therein for expanded storage space. Each of the two modular furnishing components 20D and 20E has included a shelf 28 therein used as a support for a clothes hanging rod 92. It will be appreciated that the closet organizing system 90 is just one of many possible combinations of closet organizing systems able to be built using the modular furnishing components of the invention.

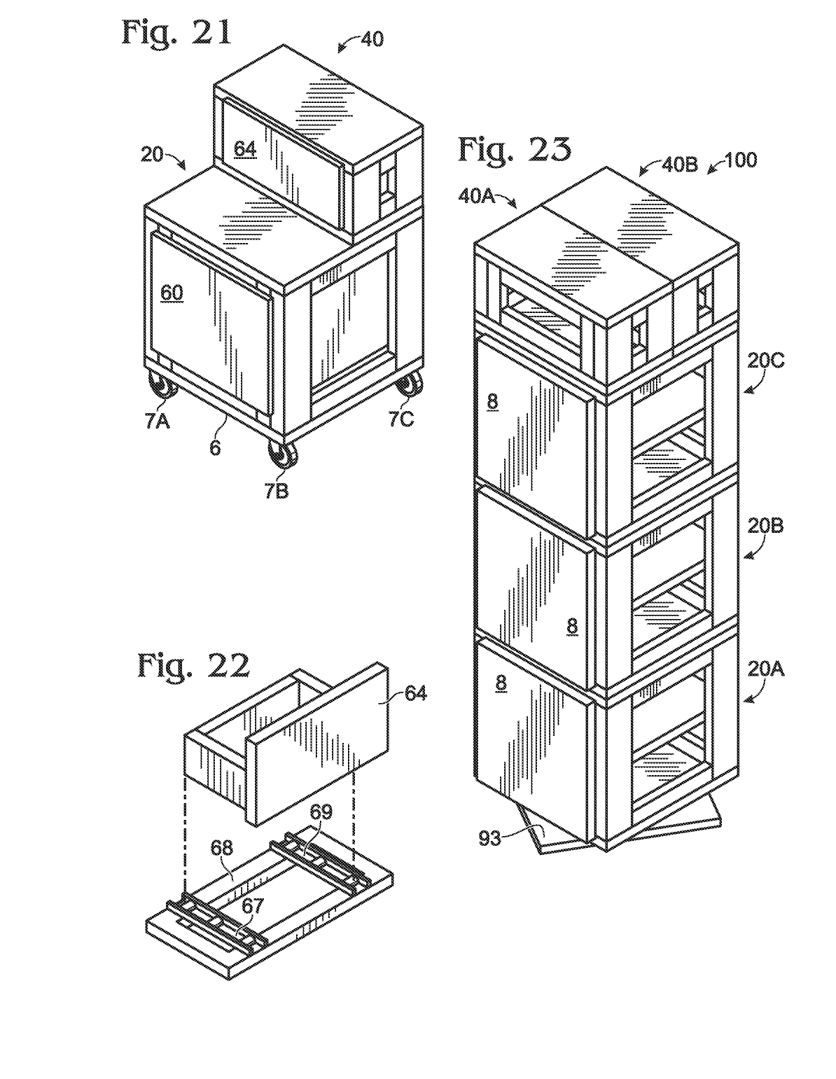

FIG. 21 shows a modular furnishing component 20 having a drawer 60 (See FIG. 9) therein and resting upon a rolling castor base 6. On top of the modular furnishing component 20 is another modular furnishing component 40 having a drawer 64 (see also FIG. 22) installed therein.

In other embodiments, the system may be configured as an “L-Shaped” corner desk made of three cube-shaped modular furnishing components 20A-20C, two rectangular box-shaped modular furnishing components 40A-40B, and one rectangular box-shaped modular furnishing component 50. The surface of the “L-Shaped” corner desk can be comprised of two plank members 66. Rectangular box-shaped furnishing component 40A can have a drawer 64 therein. Each of two cube-shaped modular furnishing components 20A and 20C can have drawers 60 therein. Other flat panel surfaces 21 are employed for decorative and finishing effect.

In other embodiments, the system may be configured as a set 110 of dining table and chairs made from two cube-shaped modular furnishing components 20 oriented diagonally adjacent and relative to each other on the floor, each component 20 having diagonally stacked thereon two rectangular boxshaped modular furnishing components 40, all components 20 and 40 being preferably of standard height. Accordingly, the heights of components 20 and 40, combined, add up to a standard table top height of 27 inches (component 20 preferably being 18 inches tall and component 40 preferably being 9 inches tall). One or more plank tops 66 rest upon, and are preferably attached to, components 40, which are in turn attached to their respective components 20, as with brackets, in order to form a solid dining table. The height of the resulting dining table 112 is convenient to allowing persons to sit at the table using standard modular furnishing components 20 as benches or chairs. The components 20 are very sturdy and thus withstand the repeating stresses of persons sitting on them.

In other embodiments, a modular furnishing system comprises at least two standard-sized, uniform components able to be combined to form a plurality of standard-sized furniture items comprising: an open-sided, cube-shaped cuboidal component, said cube-shaped component having a horizontally planar, upper square surface having four corners, said cube-shaped component also having a horizontally planar, lower planar surface having four corners, said corners of said upper surface being aligned with corresponding corners of said lower surface, and each said lower surface corner being interconnected to each said corresponding upper surface corner with at least one stile frame member; and an open-sided, rectangular box-shaped paralelliped component, said rectangular box-shaped component having a horizontally planar, upper rectangular surface having four corners, said rectangular box-shaped component also having a horizontally planar, lower planar surface having four corners, said corners of said upper surface being aligned with corresponding corners of said lower surface, and each said lower surface corner being interconnected to each said corresponding upper surface corner with at least one stile frame member; wherein said cube-shaped component and said rectangular box-shaped component are able to be stacked to form a standard-sized furnishing element. In some embodiments, the modular furnishing components of this paragraph comprise a desk.

In some embodiments, a modular furniture system and components and furniture built using the same comprise at least one open-sided, cube-shaped cuboidal component further comprising structural stile frame members, rail frame members, an upper planar surface and a lower planar surface to form the cuboidal component and at least one open-sided, rectangular box-shaped paralelliped component further comprising structural stile frame members, rail frame members, an upper planar surface and a lower planar surface to form the rectangular box-shaped component. The open-sided cube-shaped component and the open sided box-shaped paralelliped component are readily combinable to form a plurality of standard-sized furniture items with a minimal number of modular components.

The present invention may also comprise processes for cutting, with a table saw, a planer device or other suitable machine, as will be understood by those of ordinary skill in the art upon being presented with the part dimensions, such as those listed above for FIGS. 5-8, a minimum number of parts for inventory to build a maximum number of modular furnishing components 20, 30, 40, and 50. Thus, this aspect of the invention includes cut lists of the dimensions and numbers of parts necessary to create a modular furnishing component 20 that is the standard size of about 18×about 18×about 18 inches. It also includes the dimensions and numbers of parts necessary to create a modular furnishing component 30 that is the standard size of about 9×about 9×about 9 inches. It also includes the dimensions and numbers of parts necessary to create a modular furnishing component 40 that is the standard size of about 18×about 9×about 9 inches. It also includes the dimensions and numbers of parts necessary to create a modular furnishing component 50 that is the standard size of about 18×about 9×about 18 inches.

The aforementioned cut lists also reduce to a minimum the types of cuts required for the various parts disclosed. It will be appreciated by those of ordinary skill in the art that other standard size dimensions may be accommodated with similar cut lists according to a formula that expresses the dimension in terms of fractions of the standard size. Preferably, a formula for generating cut lists for standard-sized components is expressed as follows:

Cutting of stiles, rails and planar surfaces for a cube-shaped modular component 20 to thickness, width and length dimensions according to the following numbers of parts: 2×planar surface members, 8×rail members, 4×stile members (size 1), and 4×stile members (size 2), wherein all stiles, rails and planar surface members are of a thickness= 1/24×standard; wherein each planar surface member is of a length=1×standard and a width of 1×standard; wherein all stile lengths= 91.67/100×standard, all stile widths (size 1)= 1/9×standard; all stile widths (size 2)= 1/14.4×standard; wherein all rail widths= 1/14.4×standard; and wherein all rail lengths= 77.7/100×standard. In the aforementioned formula, it is assumed that the standard dimension is equal in each of the x, y and z dimension directions. When constructing a modular component 20 with dimensions of about 18×about 18×about 18 inches (x, y, z coordinates) is desired, applying the above formula may yield the parts sizes listed above in association with FIG. 5.

Cutting of stiles, rails and planar surfaces for a cube-shaped modular component 30 to thickness, width and length dimensions according to the following numbers of parts: 2×planar surface members, 8×rail members, 4×stile members (size 1), and 4×stile members (size 2), wherein all stiles, rails and planar surface members are of a thickness= 1/12×standard; wherein each planar surface member is of a length=1×standard and a width of 1×standard; wherein all stile lengths= 84.03/100×standard, all stile widths (size 1)= 22.2/100×standard; all stile widths (size 2)= 13.89/100×standard; wherein all rail widths= 13.89/100×standard; and wherein all rail lengths= 5/9×standard. In the aforementioned formula, it is assumed that the standard 20 dimension is equal in each of the x, y and z dimension directions. When constructing a modular component 30 with dimensions of about 9×about 9×about 9 inches (x, y, z coordinates) is desired, applying the above formula may yield the parts sizes listed above in association with FIG. 6.

Cutting of stiles, rails and planar surfaces for a rectangular box-shaped modular component 40 to thickness, width and length dimensions according to the following numbers of parts: 2×planar surface members, 4×rail members (size 1), 4×rail members (size 2), 4×stile members (size 1), and 4×stile members (size 2), wherein all stiles and rails are cut to a thickness of 1/24th of the x-dimension standard, and wherein all planar surface members are cut to a thickness of 1/25.04× the x-dimension standard; wherein each planar surface member is of a length=1×the x-dimension standard and a width of 1×the y-dimension standard; wherein all stile lengths= 84.03/100×the y dimension standard, all stile widths (size 1)= 22.2/100×the z-dimension standard; all stile widths (size 2)= 13.89/100×the z-dimension standard; wherein all rail widths= 13.89/100×the z-dimension standard; wherein all rail lengths (size 1)= 77.7/100×the x-dimension standard, and wherein all rail lengths (size 2)= 5/9×the z-dimension standard. In the aforementioned formula, it is assumed that the standard dimension may be different for each the x, y and z-dimension directions, though preferably, the y and z dimension directions are equal. When constructing a modular component 40 with dimensions of about 18×about 9×about 9 inches (x, y, z coordinates) is desired, applying the above formula may yield the parts sizes listed above in association with FIG. 7.

Cutting of stiles, rails and planar surfaces for a rectangular box-shaped modular component 50 to thickness, width and length dimensions according to the following numbers of parts: 2×planar surface members, 8×rail members, 4×stile members (size 1), and 4×stile members (size 2), wherein all stiles and rails are cut to a thickness of 1/24×the x-dimension standard, and all planar surface members are cut to a thickness of 1/25.04×the x-dimension standard; wherein each planar surface member is of a length=1×the x-dimension standard and a width of 1×the y-dimension standard; wherein all stile lengths= 84.03/100×the y-dimension standard, all stile widths (size 1)= 1/9×the x-dimension standard; all stile widths (size 2)= 1/14.4×the x-dimension standard; wherein all rail widths= 1/14.4×the x-dimension standard; and wherein all rail lengths= 77.7/100×the x-dimension standard. In the aforementioned formula, it is assumed that the standard dimension may be different for each the x, y and z-dimension directions, though preferably, the x and z-dimension directions are equal. When constructing a modular component 50 with dimensions of about 18×about 9×about 18 inches (x, y, z coordinates) is desired, applying the above formula may yield the parts sizes listed above in association with FIG. 8.

As a result of these formulas, a minimum number of parts (rails, stiles and planar tops and bottoms—the latter two of which are preferably the same for each component) may be stored with a minimum amount of inventory allowing for a minimum amount of warehouse space. This is accomplished, in part, in that the invention provides a minimum number of sizes and types of uniform rails, as a stock of parts, able to be used in each component. This is also accomplished, in part, in that the invention provides a minimum number of sizes and types of uniform styles, as a stock of parts, able to be used in each component. Also, in accordance with the invention, there is disclosed a modular furnishing component system that allows for a minimum number of components to create a maximum number of standard-sized furniture types. Thus, there is accomplished the objective of ability to build a maximum number of standard-sized furnishing combinations from storage of a minimum number of Stock Keeping Units (SKUs) (modular furnishing components). This in turns allows an effective number of SKUs to be stored in a smaller warehouse.

After the process of cutting the parts to appropriate sizes for each of the modular furnishing components, a process is provided preferably comprising the steps of notching, boring and grooving each of the parts together. A plurality of bore holes are provided in each of the stiles, rails and planar surface members to enable interconnecting these parts with the use of a plurality of dowels, one dowel for each matching and adjacent set of bore holes in facing rails/planar surface members, rails/size 1 stiles, rails/size 2 stiles, and size 1/size 2 stiles.

Grooves are cut in each of the stiles and rails for appearance purposes to give the appearance that there is only one size of stiles and the appearance of continuity of rail grooves around the entire module. Each size 1 stile is joined along its length with dowel construction to, and along the length of, a corresponding size 2 stile, each such pair of 5 stiles being joined to form a corner of the module. Four such corners of the module, each comprising a size 1 and a size 2 stile, are interconnected at a top and a bottom area of each corner, by upper and lower rails extending in each direction at 90-degree angles to each adjacent rail of the same type (upper or lower), and so on, until a cube-shaped, or rectangular box-shaped frame is formed. After each such cube-shaped, or rectangular box-shaped frame is thus formed, each frame is topped with a planar surface member and bottomed with a planar surface member, each such planar surface member being joined to the upper and lower rails, respectively, via a dowel interconnecting each adjacent bored hole in the rails and planar surface members. Wood glue is suitably employed in each bore and dowel joint to hold the joint firmly in place. It will be appreciated that the stiles and rails can also be attached by any other appropriate construction method, including the ones disclosed herein.

In some embodiments, a process of cutting wood to appropriately-sized parts for modular furnishing components comprises the steps of cutting rails, stiles and planar surface areas according to a formula for creating a uniform cube-shaped module having equal standard dimensions in each of x, y and z dimensions, said formula for cutting stiles comprising cutting all rails, stiles and planar surface areas to a thickness of 1/24 of one of said standard dimensions, cutting a plurality of planar surfaces areas to a width of 1×one of said standard dimensions and a length of 1×one of said standard dimensions, cutting a plurality of first stiles to a width of 1/9 of one of said standard dimensions, cutting a plurality of second stiles to a width of 1/14.4 of one of said standard dimensions, cutting each of said first stiles and each of said second stiles to a length of 91.67/100 of one of said standard dimensions, and cutting a plurality of rails to a width of 1/14.4 of one of said standard dimensions and a length of 77.7/100 of one of said standard dimensions.

While a preferred embodiment of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention.

We claim:

1. A modular furniture system comprising:
a first modular three-dimensional component having x, y, z dimensions of about 18 inches by about 18 inches by about 18 inches and a horizontal member;
a second three-dimensional modular component having a horizontal member and arrangable with the first modular component to form modular furniture; and
a connector having a planar middle section with a first protruding section integral with a first side of the middle section and a second protruding section integral with a second side of the middle section, the first and second protruding sections protruding substantially perpendicular relative to the planar middle section, wherein the connector is adapted to connect together the first and second modular components.

2. The modular furniture system of claim 1, wherein the first protruding section protrudes in an opposite direction to the second protruding section, relative to the middle section, to form the connector into substantially an s-shape.

3. The modular furniture system of claim 2, wherein the connector is attachable to a wall with one or more screws insertable through one or more holes of the first protruding section as to form a downward facing cavity between the middle section, the second protruding section, and the wall, the cavity being sized to secure the horizontal member of the first or second modular component within the cavity.

4. The modular furniture system of claim 2, wherein the connector is attachable to the wall with one or more screws through one or more holes of the first protruding section as to form an upward facing cavity between the middle section, the second protruding section, and the wall, the cavity being sized to secure the modular furniture within the cavity to the wall.

5. The modular furniture system of claim 2, wherein the first modular component is positioned above the second modular component and the two components are secured together with the connector that is interposed between the two components.

6. The modular furniture system of claim 5, wherein two components are secured by one or more screws inserted through one or more holes of the first protruding section into a top surface of the first modular component and through one or more holes of the second protruding section into a bottom portion of the second modular component.

7. The modular furniture system of claim 1, wherein the first and second protruding sections protrude in substantially the same direction away from the middle section to form the connector into substantially a u-shape.

8. The modular furniture system of claim 7, wherein the u-shaped connector adjoins together the horizontal member of the first modular component with the horizontal member of the second modular component.

9. The modular furniture system of claim 8, wherein the horizontal member of the first modular component is proximate a top end of the first modular component.

10. The modular furniture system of claim 8, wherein the u-shaped connector is formed by mounting a first s-shaped connector to a second s-shaped connector to form a substantially u-shaped cavity, wherein the u-shaped cavity is sized to fit a portion of the first modular component adjoined to a portion of the second modular component.

11. The modular furniture system of claim 1, wherein the second modular component has x, y, z dimensions of about 18 inches by about 9 inches by about 9 inches.

12. The modular furniture system of claim 11, further comprising:
a third three-dimensional modular component having x, y, z dimensions of about 9 inches by about 9 inches by about 9 inches; and
a fourth three-dimensional modular component having x, y, z, dimensions of about 18 inches by 9 inches by 18 inches;
wherein the first, second, third, and fourth modular components are arrangable to form modular furniture.

13. A modular furniture system comprising:
an open-sided, cube-shaped cuboidal component, the cube-shaped component having a horizontally planar, upper square surface having four corners and a horizontally planar, lower planar surface having four corners, the corners of the upper surface being aligned with corresponding corners of the lower surface, each lower surface corner being interconnected to each corresponding upper surface corner with at least one stile frame member; and
an open-sided, rectangular box-shaped paralelliped component, the rectangular box-shaped component having a horizontally planar, upper rectangular surface having four corners and a horizontally planar, lower planar surface having four corners, the corners of the upper surface being aligned with the corresponding corners of the lower surface, each lower surface corner being interconnected to each said corresponding upper surface corner with at least one stile frame member;
wherein said cube-shaped component and said rectangular box-shaped component are joinable to form a standard-sized furnishing element.

14. A desk comprised of the modular furnishing components of claim 13.

15. The modular furniture system of claim 13, wherein the cuboidal component has x, y, z dimensions of about 18 inches by about 18 inches by about 18 inches, and the paralelliped component has x, y, z dimensions of about 18 inches by about 9 inches by about 9 inches.

16. The modular furniture system of claim 13, wherein the cuboidal component has x, y, z dimensions of about 9 inches by about 9 inches by about 9 inches, and the paralelliped component has x, y, z dimensions of about 18 inches by about 9 inches by about 18 inches.

17. The modular furniture system of claim 13, further comprising an s-shaped bracket that is attachable to a wall forming a cavity between a protruding portion of the s-shaped bracket and the wall, wherein a portion of the standard-sized furnishing element is securable within the cavity.

18. A process of creating modular furnishing components comprising the steps of:
cutting rails, stiles and planar surface areas according to a formula for creating a uniform cube-shaped module having an equal standard dimension in each of the x, y and z dimensions, said formula for cutting stiles comprising:
cutting all rails, stiles and planar surface areas to a thickness of 1/24 of the standard dimension;
cutting a plurality of planar surfaces areas to a width of 1×the standard dimensions and a length of 1×the standard dimension;
cutting a plurality of first stiles to a width of 1/9 of the standard dimension;
cutting a plurality of second stiles to a width of 1/14.4 the standard dimension;
cutting each of the first stiles and each of the second stiles to a length of 91.67/100 of the standard dimension; and
cutting a plurality of rails to a width of 1/14.4 of the standard dimension and a length of 77.7/100 of the standard dimension; and
forming the cut rails, stiles, and planar surfaces into a three-dimensional modular component having equal x, y, z dimensions.

19. The method of claim 18, wherein the standard dimension is about 18 inches.

20. A modular furniture system comprising:
a three-dimensional first modular component having x, y, z dimensions of about 18 inches by about 18 inches by about 18 inches;
a three-dimensional second modular component having x, y, z dimensions of about 9 inches by about 9 inches by about 9 inches;
a three-dimensional third modular component having x, y, z dimensions of about 18 inches by about 9 inches by about 9 inches; and
a three-dimensional fourth modular component having x, y, z dimensions of about 18 inches by 9 inches by 18 inches,
wherein the first, second, third, and fourth modular components are arrangable to form modular furniture.
